(19) United States
(12) Patent Application Publication
(10) Pub. No.: US 2013/0265501 A1
(43) Pub. Date: Oct. 10, 2013

(54) REMOTE TOUCH GESTURES

(71) Applicants: Sivakumar Murugesan, San Diego, CA (US); Yukinori Taniuchi, Tokyo (JP); Taro Kaneko, Chiba (JP); Sriram Sampathkumaran, San Diego, CA (US); Abhishek P. Patil, San Diego, CA (US); Bibhudendu Mohapatra, San Diego, CA (US)

(72) Inventors: Sivakumar Murugesan, San Diego, CA (US); Yukinori Taniuchi, Tokyo (JP); Taro Kaneko, Chiba (JP); Sriram Sampathkumaran, San Diego, CA (US); Abhishek P. Patil, San Diego, CA (US); Bibhudendu Mohapatra, San Diego, CA (US)

(73) Assignee: SONY CORPORATION, Tokyo (JP)

(21) Appl. No.: 13/605,079

(22) Filed: Sep. 6, 2012

Related U.S. Application Data
(60) Provisional application No. 61/621,658, filed on Apr. 9, 2012.

(51) Int. Cl. H04N 5/44

(52) U.S. Cl. 348/734; 348/E05.096

(57) ABSTRACT

A remote control (RC) has a touch pad and user touches on the pad are correlated to pad positions. The positions are sent to a remote display device and mapped to corresponding locations on the display of the display device as though the user were touching the display of the display device, not the touch pad of the RC.

This application claims priority to U.S. provisional application 61/621,658, filed Apr. 9, 2012, incorporated herein by reference.

### I. FIELD OF THE INVENTION

The present application relates generally to remote controls (RC) for controlling audio video display devices (AVDD) such as TVs.

### II. BACKGROUND OF THE INVENTION

Modern TVs such as the Sony Bravia (trademark) present native user interfaces (UI) to allow viewers to select an audio video (AV) input source, to launch non-broadcast TV applications such as video telephone applications (e.g., Skype), and so on. As understood herein, many viewers of TVs may prefer to access application-based UIs, with which many viewers may be as or more familiar than they are with native TV UIs, and which increase a viewer's range of choices by allowing a user to view application-based content such as Internet video.

In any case, users continue to expect to control TVS using remote controls (RC). Conventionally, user input to consumer electronics products is mainly through buttons and a mouse except one with touch screen. As understood herein, however, user gestures and touch input are a convenient, easy and intuitive way for user to provide input specifically for devices offering entertainment like TV, set top box (STB), and devices supporting applications without touch screen. Since these devices are not hand held devices, they don't have touch screen but have remotes.

### SUMMARY OF THE INVENTION

A remote control (RC) for a video display device (VDD) uses touch gestures as a solution for ease of operation of entertainment devices. Both absolute touches are used, in which a track pad area of the RC is mapped to a screen area of the VDD and the track pad simulates screen display (touch screen) for the user, allowing the user to touch specific areas on the screen by touching the corresponding area on track pad. Touch inputs such as tap, press, etc. are sent to the VDD and the VDD processes the inputs as if they come from the (non-touch) display of the VDD.

Additionally, various gestures can be derived based on movement of a user finger over the RC touch pad and can be mapped to various events depending on the application involved.

Accordingly, a remote control (RC) includes a portable hand held housing, a touch sensitive surface on the housing, and a processor in the housing communicating with the surface. A wireless transmitter is controlled by the processor. A computer readable storage medium is accessible to the processor and bears instructions executable by the processor to configure the processor to receive a signal representing a touch on the surface, and determine a type of touch based on the signal representing a touch on the surface. The processor determines a location of the touch on the surface and transmits a signal representing the type of touch and the location of the touch to a video device.

The location can be a geometric location on the surface, and specifically can be a location on a matrix grid system, and the signal sent to the display device indicates the geometric location. The type of touch may be a tap, a click characterized by greater finder pressure on the surface than a tap, a double tap, a long push characterized by pressure against an area of the surface for a period exceeding a threshold period, or a pinch.

In another aspect, a remote control (RC) includes a portable hand held housing, a touch sensitive surface on the housing, and a processor in the housing communicating with the surface. A wireless transmitter is controlled by the processor. A computer readable storage medium is accessible to the processor and bears instructions executable by the processor to configure the processor to send touch-generated signals to a video device. The housing supports, in addition to the touch sensitive surface, a navigation rocker manipulable to move a screen cursor up, down, left, and right, a home key, a play key, a pause key, and a guide key.

In another aspect, remote control (RC) has a touch pad and user touches on the pad are correlated to pad positions. The positions are sent to a remote display device and mapped to corresponding locations on the display of the display device as though the user were touching the display of the display device, not the touch pad of the RC.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a flow chart of example RC logic;

FIG. 3 is a flow chart of example video display device (VDD) logic;

FIG. 4 is a plan view of an example implementation of the VDD RC, showing side views exploded away from the plan view;

FIG. 5 is a plan view of an example implementation of the AVAM RC;

FIG. 6 is a plan view of an example implementation of the keyboard for either RC;

FIG. 7 is a plan view of the touch pad of one of the RCs illustrating scroll areas;

FIG. 8 is a plan view of the touch pad of one of the RCs illustrating function areas; and

FIGS. 9-12 are tables indicating various example touch types.

### DETAILED DESCRIPTION OF THE PREFERRED EMBODIMENT

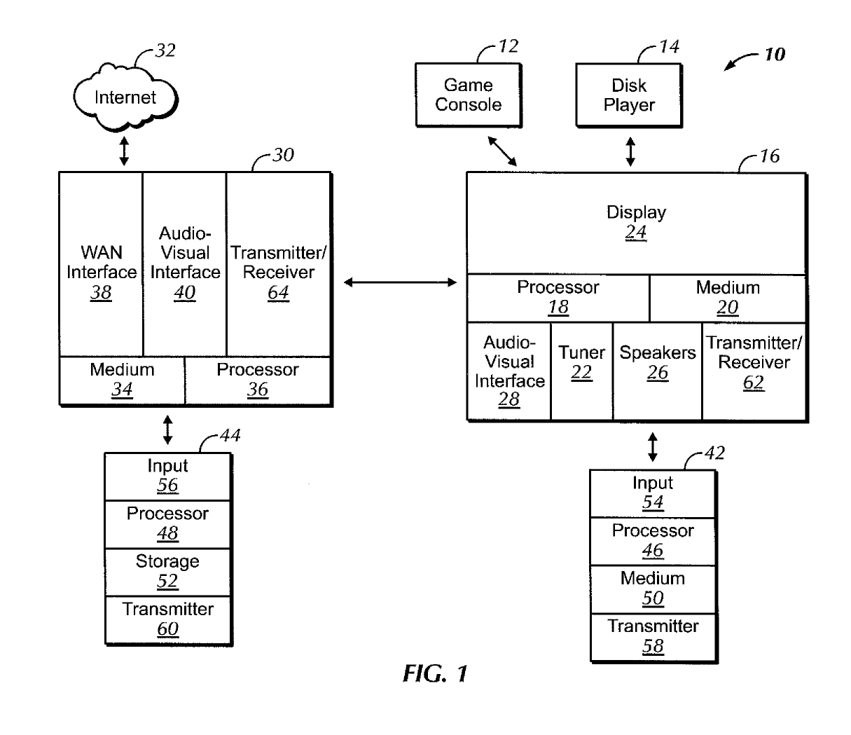

Referring initially to the exemplary embodiment shown in FIG. 1, a system generally designated 10 is shown. The system 10 includes a game console 12 and a disk player 14. The system 10 also includes a display device 16 that includes a processor 18, tangible computer readable storage medium 20 such as disk-based or solid state storage, a tuner 22, display 24, and speakers 26. In some embodiments, the display device 16 may be, but is not limited to, a television (TV) such as a Sony Bravia high-definition television manufactured by Sony Corporation. In some examples, the TV processor executes a Linux operating system to provide applications apart from TV channel presentation. It is to be understood that the display device 16 may present on the display 24 and/or speakers 26 its own user interface (UI), referred to herein as a “native” UI under control of the processor 18.

The device 16 also includes an audio-visual (A/V) interface 28 to communicate with other devices such as the game console 12 and disk player 14 in accordance with present principles. The A/V interface may be used, e.g., in a high definition multimedia interface (HDMI) context for communicating over an HDMI cable through an HDMI port on the display device 16 with, e.g., the game console 12. However, other A/V interface technologies may be used in lieu of or in conjunction with HDMI communication to implement/execute present principles, as may be appreciated by those within the art. For instance, e.g., cloud computing, IP networks, national electrical code (NEC) communication, coaxial communication, fiber optic communication, component video communication, video graphics array (VGA) communication, etc., may be used.

Still in reference to FIG. 1, an audio-video application module (AVAM) 30 is shown as being connected to the Internet 32. It is to be understood that the audio-video application module 30 includes a tangible computer readable storage medium 34 such as disk-based or solid state storage, as well as a processor 36, a network interface 38 such as a wired or wireless modem or router or other appropriate interface, e.g., a wireless telephony transceiver, and an audio-visual interface 40 that is configured to communicate with the audio-visual interface 28 of the display device 16 and, if desired, any other modules in the system 10 such as the game console 12 and display player 14 over, e.g., HDMI connections or any of the other connection types listed above. The VAM 30 may execute an operating system than that executed by the TV processor. For instance, in an example embodiment the AVAM 30 is a Google TV module executing the Android operating system.

Furthermore, it is to be understood that the processor 18 and processor 36, in addition to any other processors in the system 10 such as in the game console 12 and 14, are capable of executing all or part of the logic discussed herein as appropriate to undertake present principles. Moreover, software code implementing present logic executable by, e.g., the processors 18 and 36 may be stored on one of the memories shown (the computer readable storage mediums 20 and 34) to undertake present principles.

Continuing in reference to FIG. 1, a remote commander (RC) 42 associated with the display device 16 and referred to herein as the “native” RC is shown. An RC 44 associated with the AVAM 30 is also shown. The RCs 42, 44 function according to description below, and are alike except for certain differences in keys and layouts discussed further below.

The RCs 42 and 44 have respective processors 46 and 48, respective computer readable storage mediums 50 and 52, and respective one or more input devices 54 and 56 such as, but not limited to, touch screen displays and/or cameras (for sensing user gestures on a touch surface or imaged by a camera that are then correlated to particular commands, such as scroll left/right and up/down, etc.) keypads, accelerometers (for sensing motion that can be correlated to a scroll command or other command), microphones for voice recognition technology for receiving user commands. The RCs 42 and 44 also include respective transmitters/receivers 58 and 60 (referred to herein simply as transmitters 58 and 60 for convenience) for transmitting user commands under control of the respective processors 46 and 48 received through the input devices 54 and 56.

It is to be understood that the transmitters 58 and 60 may communicate not only with transmitters on their associated devices via wireless technology such as RF and/or infrared (i.e. the transmitter 58 under control of the processor 46 may communicate with a transmitter 62 on the display device 16 and the transmitter 60 under control of the processor 48 may communicate with a transmitter 64 on the AVAM 30), but may also communicate with the transmitters of other devices in some embodiments. The transmitters 58 and 60 may also receive signals from either or both the transmitter 62 on the display device 16 and transmitter 64 of the AVAM 30. Thus, it is to be understood that the transmitters/receivers 58 and 60 allow for bi-directional communication between the remote commanders 42 and 44 and respective display device 16 and AVAM 30.

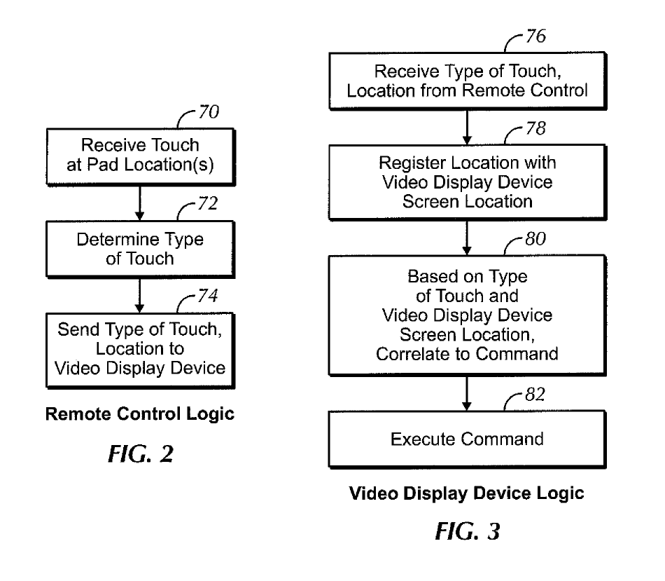

Now in reference to FIG. 2, the logic executed by an RC according to present principles is shown. For disclosure purposes, touch surface input will be assumed, it being understood that present principles apply to motion of the RC as sensed by an accelerometer, voice command as sensed by a microphone, non-touch gesture as sensed by a camera. At block 70, a touch is received on the touch pad or surface of the RC at one or more locations on the touch pad. The type of touch is determined at block 72, e.g., whether the touch is a soft or hard touch, sliding motion, indeed a release of pressure by a finger, which itself may be used to indicate a particular command. Various types of touches are divulged further below and include, among other touches, taps, clicks characterized by greater finder pressure on the touch surface than a tap, double taps, a long push characterized by pressure against an area of the touch surface for a period exceeding a threshold period, and pinched. Likewise, various types of motion of the RC as sensed by the accelerometer can be correlated to commands, e.g., a motion to the left can be interpreted as a command to “scroll left” while a motion to the right can be interpreted as a command to “scroll right”. Similarly, hand gestures imaged by the camera can be correlated to respective commands.

Then, at block 74 the type of touch along with the location(s) of the touch on the pad are sent to a video device (VD) such as the display device 16 or AVAM 30. The location is a geometric location on the display and in one implementation is a location on a matrix grid system, and the signal sent to the video device indicates the geometric location.

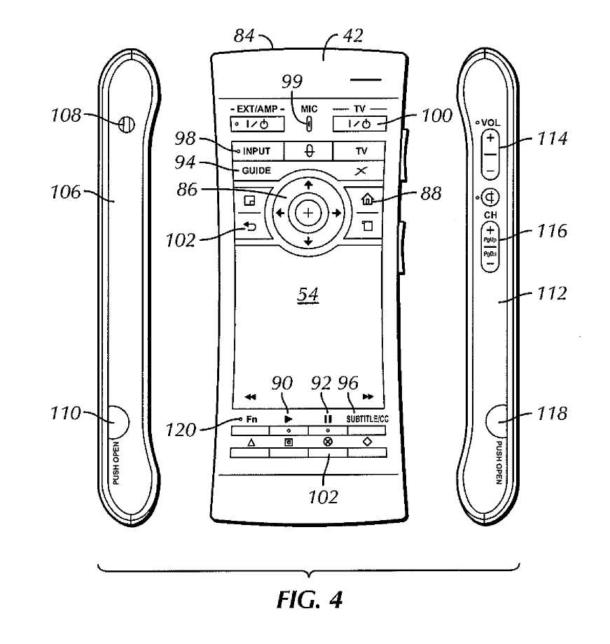

Complementary logic that is executed by a video device receiving signals from the RC is shown in FIG. 3. At block 76 the type of touch and location of the touch are received from the RC. Block 78 indicates that the location received from the RC is registered to a geometrically equivalent location on a display controlled by the video device. For example, assume the touch surface of the RC has a matrix of touch points numbering 100 by 100, and the location received from the RC indicates a touch at point in the matrix 10 units from the top and 10 units from the right edge. Assume that the display controlled by the video device has a display 1000 pixels by 1000 pixels. At block 78 the video device converts the location signal from the RC to a geometrically equivalent location on its display by multiplying by ten, determining that the touch should be regarded as having occurred relative to the display controlled by the video device 100 pixels from the top and 100 pixels from the right edge of the display.

Proceeding to block 80, based on the type of touch and geometrically equivalent display location, the video device correlates the touch signal to a command, which is executed at block 82 by the video device. Thus, for example, knowing a tap was received and knowing what selector element of a user interface corresponds to the geometrically equivalent display position determined at block 78, the video device knows what the user manipulating the RC and viewing the display intended to select by the touch, and by the nature (type) of the touch knows which one of potentially multiple commands, each associated with a type of touch, the user intended by the selection of the selector element.

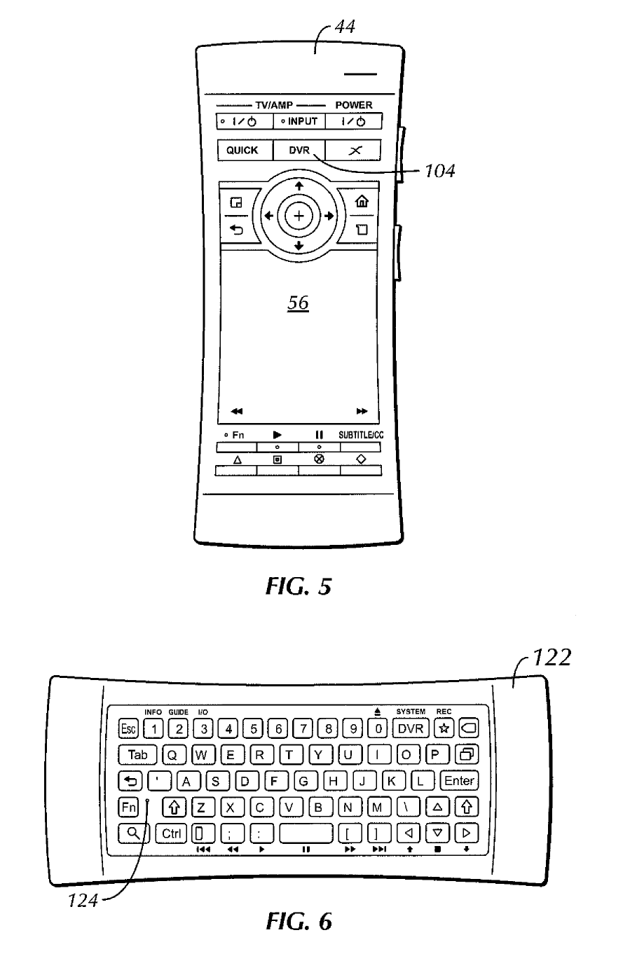

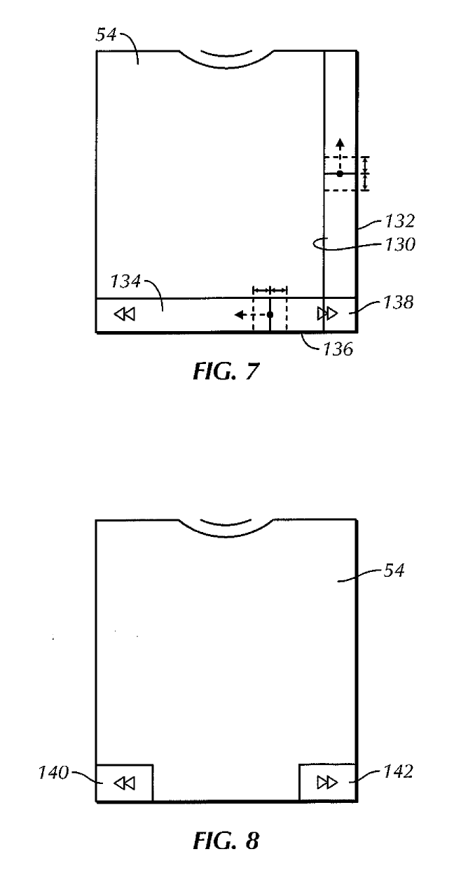

FIG. 4 shows an example implementation of the display device RC 42 shown in FIG. 1, while FIG. 5 shows an example implementation of the AVAM RC 44 shown in FIG. 1. As shown in FIG. 4, the RC 42 includes a portable hand held housing 84 that holds the above-described touch sensitive surface 54, processor, wireless transmitter, and computer readable storage medium. In addition to the touch sensitive surface, a navigation rocker 86 is on the housing and is manipulable to move a screen cursor up, down, left, and right, as shown by the arrows on the rocker 86. Note that the rocker 86 may not actually physically rock about axes but may include four separate touch areas or switches. Also, a home key 88, a play key 90, a pause key 92, and a guide key 94 are on the housing as shown to respectively cause a controlled display to show a home menu, play a video, pause the video, and present a program guide. The play and pause keys may be below (relative to the user, i.e., closer to the user's torso) the touch pad 54 as shown while the home and guide keys and rocket 86 may be above the touch surface.

Also supported on the housing is a subtitle key 96 manipulable to cause a video device in wireless communication with the RC to present subtitles on a display. Moreover, an input key 98 is manipulable to cause a video device in wireless communication with the RC to change a content input to a display. A microphone 99 may be supported on the housing for voice command input. Above the input key 98 are side-by-side power keys 100 for energizing and deenergizing a controlled display device and an associated amplifier. Additional keys may include a back key 102 for causing a controlled device to return to a previous menu or screen and letter keys A-D 104, each with a distinctive geometric boundary as shown, for inputting respective control signals typically in response to a display prompting input of a particular letter for a particular command or service. All of these keys are also contained on the RC 44 in FIG. 5 as shown, except that the input key 98 on the RC 42 of FIG. 4 is below the power keys 100 while on the RC 44 in FIG. 5 is in the same row as the power keys. Also, the RC 44 in FIG. 5 contains a digital video record (DVR) key 104 to cause commands to be sent a DVR.

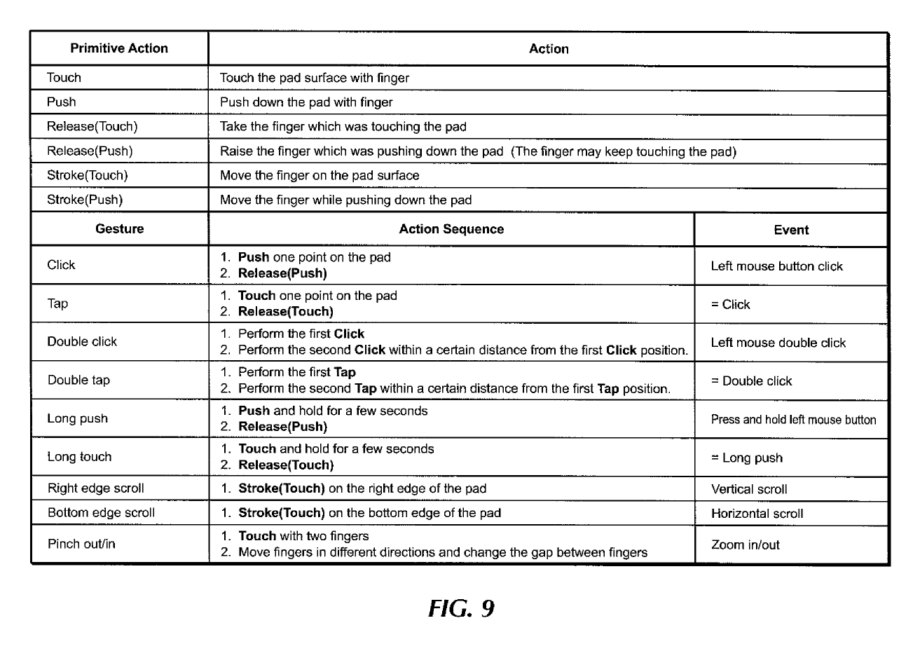

As also shown in FIG. 4, it being understood that the side surfaces of the RC 44 shown in FIG. 5 may include identical structure, the left side surface 106 of the RC 42 includes an indicator light 108 such as a light emitting diode (LED) to indicate the presence of a communication link between the RC 42 and a controlled device. A release button 110 may also be provided to release a battery cover of the device. On the right side surface 112 are volume up/down selectors 114 and channel up/down selectors 116, and a second button 118 to release a battery cover of the device. Just below the touch pad 54 a “function” indicator light 120 may be disposed on the housing to indicate a function currently invoked. Either RC 42, 44 may be coupled to a keyboard 122 shown in FIG. 6 with function light 124 which may be illuminated at the same time as the function light 120 on the RC so that both the keyboard and RC indicate a connection therebetween exists.

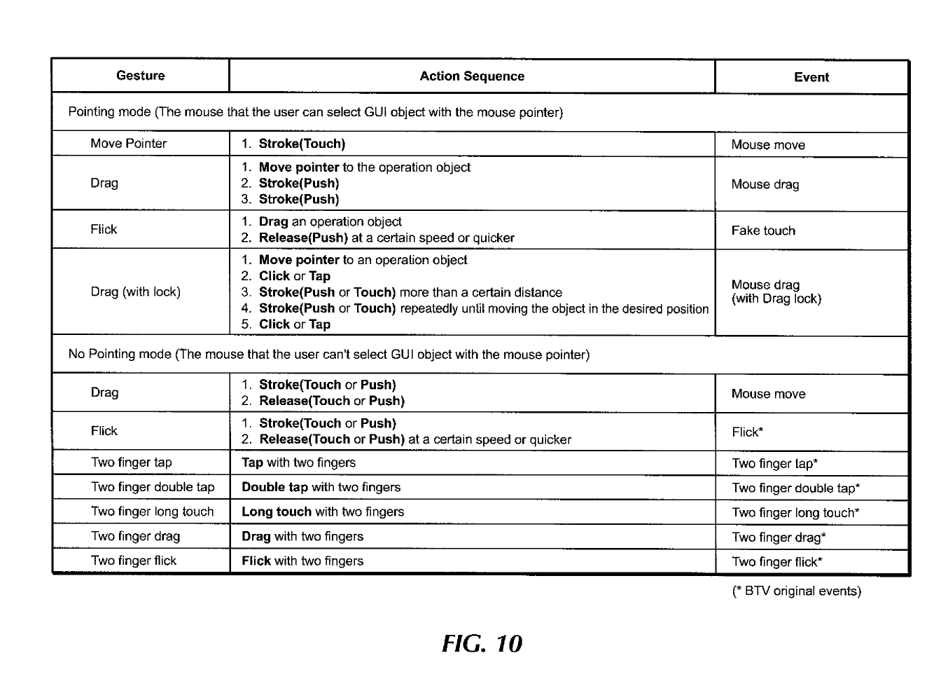

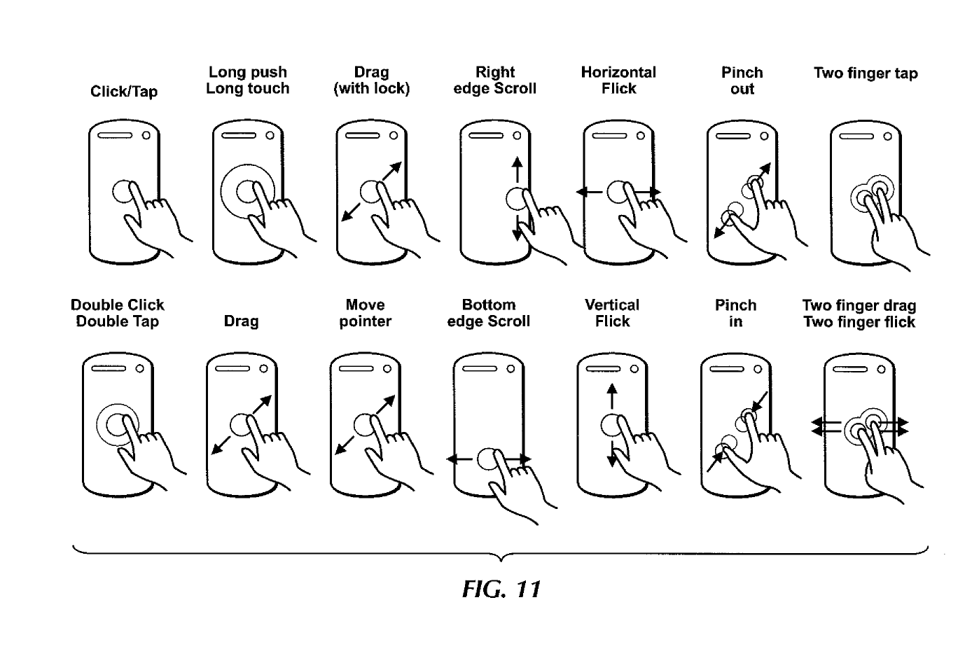

FIGS. 7 and 8 show that the touch surface 54 of the RC 42 (with the same disclosure applying to the touch surface of the RC 44) may include dedicated regions which, when touched, invoke particular predetermined commands. Specifically, a right scroll area 130 may be defined along a right edge 132 of the touch sensitive display 54. Responsive to a user stroke in the right scroll area 130, the RC processor sends a signal to a video device to move a screen presentation (such as a cursor or series of thumbnails) up or down in the direction of the stroke. Likewise, a bottom scroll area 134 may be defined along a bottom edge 136 of the touch sensitive surface, and responsive to a user stroke in the bottom scroll area 134, the RC processor sends a signal to a video device to move a screen cursor left or right in the direction of the stroke. In one implementation, the scrolling of the cursor continues as long as the user's finger remains on contact with the surface 54, whether moving or nor and whether inside the scroll area or not. Scrolling stops when the user's finger is released from the surface. Accordingly, in this example a release of pressure by a finger is interpreted as command to “stop scrolling”. Note that the areas 130, 134 may not be invoked as described until a user presses for a predetermined time on a predetermined keying area of the touch surface, such as the right bottom corner 138.

FIG. 8 shows additional dedicated areas of the touch surface 54 that may be defined. A fast reverse key area 140 may be defined on a first corner (such as the left bottom corner as shown) of the surface 54. Responsive to a user touch in the fast reverse key area 140, the RC processor sends a signal to a video device to play content currently being played by the video device in fast reverse. Also, a fast forward key area 142 may be defined on a second corner (such as the right bottom corner as shown) of the surface. Responsive to a user touch in the fast forward key area, the RC processor sends a signal to a video device to play content currently being played by the video device in fast forward.

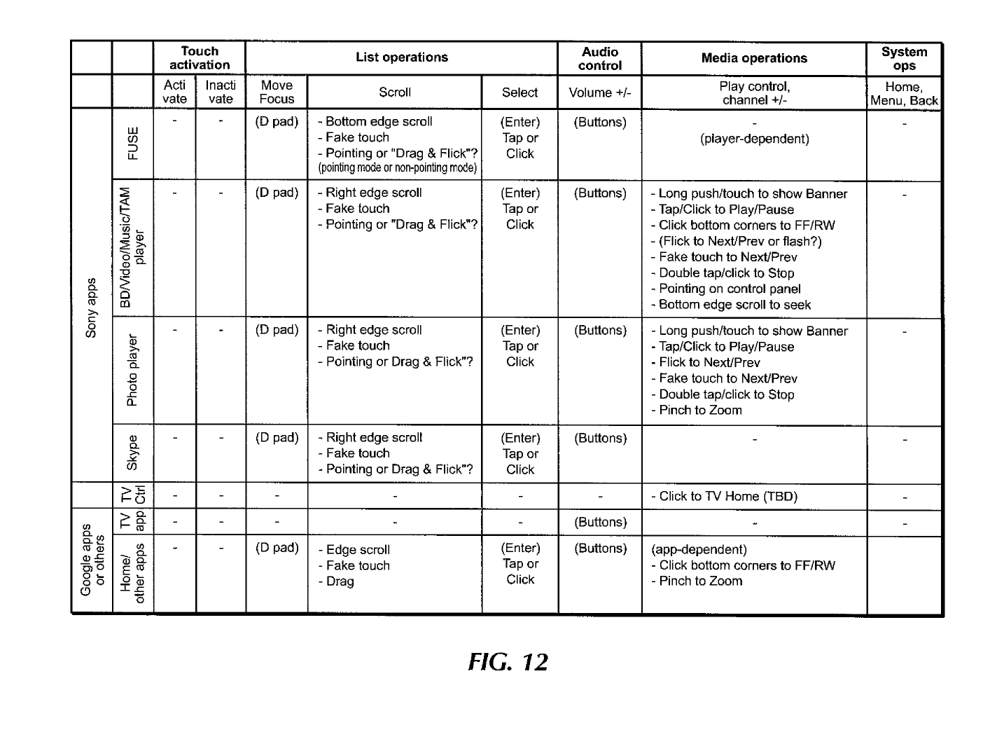

FIGS. 9-11 illustrate various example non-limiting touch types and their definitions, while FIG. 12 correlates certain touch types to specific commands for multiple applications listed in the left column of FIG. 12.

While the particular REMOTE TOUCH GESTURES is herein shown and described in detail, it is to be understood that the subject matter which is encompassed by the present invention is limited only by the claims.

What is claimed is:

1. A remote control (RC) comprising:
a portable hand held housing;
at least one touch sensitive surface on the housing;
at least one processor in the housing communicating with the surface;
at least one wireless transmitter controlled by the processor; and
computer readable storage medium accessible to the processor and bearing instructions executable by the processor to configure the processor to:
receive a signal representing a touch on the surface;
determine a type of touch based on the a signal representing a touch on the surface;
determine a location of the touch on the surface; and
transmit a signal representing the type of touch and the location of the touch to a video device.

2. The RC of claim 1, wherein the location is a geometric location on the surface.

3. The RC of claim 2, wherein the geometric location is a location on a matrix grid system, and the signal sent to the display device indicates the geometric location.

4. The RC of claim 1, wherein the type of touch is a tap.

5. The RC of claim 1, wherein the type of touch is a click characterized by greater finder pressure on the surface than a tap.

6. The RC of claim 1, wherein the type of touch is a double tap.

7. The RC of claim 1, wherein the type of touch is a long push characterized by pressure against an area of the surface for a period exceeding a threshold period.

8. The RC of claim 1, wherein the type of touch is a pinch.

9. A remote control (RC) comprising:
a portable hand held housing;
at least one touch sensitive surface on the housing;
at least one processor in the housing communicating with the surface;
at least one wireless transmitter controlled by the processor; and
computer readable storage medium accessible to the processor and bearing instructions executable by the processor to configure the processor to send touch-generated signals to a video device, wherein
the housing supports, in addition to the touch sensitive surface, a navigation rocker manipulable to move a screen cursor up, down, left, and right, a home key, a play key, a pause key, and a guide key.

10. The RC of claim 9, wherein the housing further supports:
a subtitle key manipulable to cause a video device in wireless communication with the RC to present subtitles on a display.

11. The RC of claim 9, wherein the housing further supports:
an input key manipulable to cause a video device in wireless communication with the RC to change a content input to a display.

12. The RC of claim 9, further comprising a keyboard coupled to the housing.

13. The RC of claim 9, wherein the touch sensitive surface on the housing includes a right scroll area along a right edge of the touch sensitive surface on the housing, wherein responsive to a user stroke in the right scroll area, the processor sends a signal to a video device to move a screen presentation up or down in the direction of the stroke.

14. The RC of claim 9, wherein the touch sensitive surface on the housing includes a bottom scroll area along a bottom edge of the touch sensitive surface on the housing, wherein responsive to a user stroke in the bottom scroll area, the processor sends a signal to a video device to move a screen presentation left or right in the direction of the stroke.

15. The RC of claim 9, wherein the touch sensitive surface on the housing includes a fast reverse key area on a first corner of the surface, wherein responsive to a user touch in the fast reverse key area, the processor sends a signal to a video device to play content currently being played by the video device in fast reverse.

16. The RC of claim 9, wherein the touch sensitive surface on the housing includes a fast forward key area on a second corner of the surface, wherein responsive to a user touch in the fast forward key area, the processor sends a signal to a video device to play content currently being played by the video device in fast forward.

17. A remote control (RC) comprising:
a touch surface;
a wireless transmitter sending signals to a controlled device responsive to user touches on the touch surface, the signals indicating positions on the surface at which the user touched the surface, the positions being sent to a remote display device and mapped to corresponding locations on the display of the display device as though the user were touching the display of the display device, not the touch surface of the RC.

18. The RC of claim 17, comprising a processor in the RC configured to:
determine a type of touch based on the touch on the surface;
determine a location of the touch on the surface; and
transmit a signal representing the type of touch and the location of the touch to a video device.

19. The RC of claim 17, wherein the location is a geometric location on the surface.

20. The RC of claim 17, wherein the RC includes a housing bearing:
a navigation rocker manipulable to move a screen cursor up, down, left, and right, a home key, a play key, a pause key, and a guide key.
